(19) United States
(12) Patent Application Publication
(10) Pub. No.: US 2003/0023410 A1
(43) Pub. Date: Jan. 30, 2003

(54) Method and apparatus for flushing of a device cache and suspending/shutting-down the device

(76) Inventor: Eric Scott Roth, Santa Monica, CA (US)

Correspondence Address: NEXT PLANET, IN.C, 175 S. FAIR OAKS AVE., PASADENA, CA, 91105, US

(21) Appl. No.: 10/064,489

(22) Filed: Jul. 20, 2002

Related U.S. Application Data
(60) Provisional application No. 60/306,815, filed on Jul. 20, 2001.

(51) Int. Cl. G06F 15/00

(52) U.S. Cl. 702/188

(57) ABSTRACT

Attorney Docket No.: RP.P006Page 12 of 14Express Mail No.: Jun. 3, 2002A method of initiating a suspension of a device connected to a parent device. The method including the steps of receiving a request from a user; generating an interrupt signal from the device to the parent device; concluding any data transfers between the device and the parent device; and, providing an indication to the user once all data transfers between the device and the parent device have concluded.

### CROSS REFERENCE TO RELATED APPLICATIONS

The present application is a non-provisional application that claims the benefit of a provisional application, application No. 60/306,815, filed Jul. 20, 2001, entitled “Method and apparatus of flushing a device cache and suspending/shutting-down the device,” by inventor Eric Roth, currently pending.

### BACKGROUND OF INVENTION

Currently, users are adding additional functionality to their computers by using external computer peripherals. These external peripherals include external hard drives, optical disc readers/recorders, digital cameras and camcorders, and digital music players. These external peripherals may use such interconnection technologies as Universal Serial Bus (USB), Institute of Electrical and Electronic Engineers (IEEE)-1394 (also known as “Firewire”) or Small Computer System Interface (SCSI). In the case of external storage devices such as the aforementioned external hard drives and optical disc readers/recorders, a buffer on the computer is typically used to buffer access to data contained on the external storage devices by either prefetching data or storing data that needs to be written back to the device. Where the buffer contains data to be written back to the storage device, problems can occur if the external storage device is removed before the computer has had the opportunity to finish writing data from the buffer back to the storage device. The unwritten data is lost, even if the storage device is plugged back into the computer. This can result in corruption of the data in the storage device, and may even render the storage device unusable.

One solution to prevent data loss from unwritten data in the buffer is to require a user to actively request an approval of the removal of a device. An existing solution is to require the user to use a cursor control device such as a mouse to select or toggle a graphical user interface element on a display connected to the computer such as a button or a selection in a graphical menu. However this procedure is typically cumbersome, requiring the user to be in front of the computer display, locate the graphical element on the display and select it. Moreover, the graphical element is often small and difficult to locate.

Thus, a system that addresses one or more of the above problems is desirable.

### BRIEF DESCRIPTION OF DRAWINGS

The system is illustrated by way of example and not limitation in the figures of the accompanying drawings in which like references indicate similar elements and in which:

FIG. 1 is a system diagram of a computer system configured in accordance with one embodiment of the present invention.

FIG. 2 is a flow diagram illustrating the steps of initiating the flushing a device cache and suspending/shutting-down a device according to one embodiment of the present invention.

FIG. 3 is a flow diagram illustrating the steps of initiating the flushing a device cache and suspending/shutting-down a device according to another embodiment of the present invention.

### DETAILED DESCRIPTION

The present invention discloses a method and apparatus of flushing a device cache and suspending/shutting-down the device. In the following description, numerous specific details are set forth in order to provide a thorough understanding of the present invention. However, it will be apparent to one skilled in the art that the present invention may be practiced without these specific details. In other instances, well-known circuits, structures, and the like are not described in detail so as not to obscure the present invention unnecessarily. Moreover, although the present invention is described with reference to a external storage device, it will be appreciated that the invention has application to other systems where devices having data that need to be written to or read from it may be disconnected from the system without data loss. Accordingly, the specific reference to an external storage device in this Specification is not to be understood as a limitation in the application of the invention.

In one embodiment of the present invention, a device such as a external storage device (e.g., an external hard drive), is provided with a button on an easily accessible location, such as on a panel of the device, that is used to safely prepare the device for removal from a parent device such as a computer system. The button is used when the user wishes to remove a drive while the parent device is powered and active. The device is attached to the computer system via a detachable connection. When pressed, the button will initiate a signal that is recognized by the computer system and that causes the following to occur:

1.A warning message is issued to the user.

2.1f the user wishes to proceed, the write buffer in the computer system (e.g., parent device) is flushed to the storage device (e.g., device).

3.A standby (e.g. ATA E0 Standby Immediate) command is issued to the storage device.

4.At the receipt of the command, the storage device will prepare for shutdown.

For example a hard drive will park its heads and spin down the media.

5.The device driver in the operating system of the computer system will unmount the storage device from the operating system and remove it from the operating system.

6.The user is then notified that the drive can be removed safely.

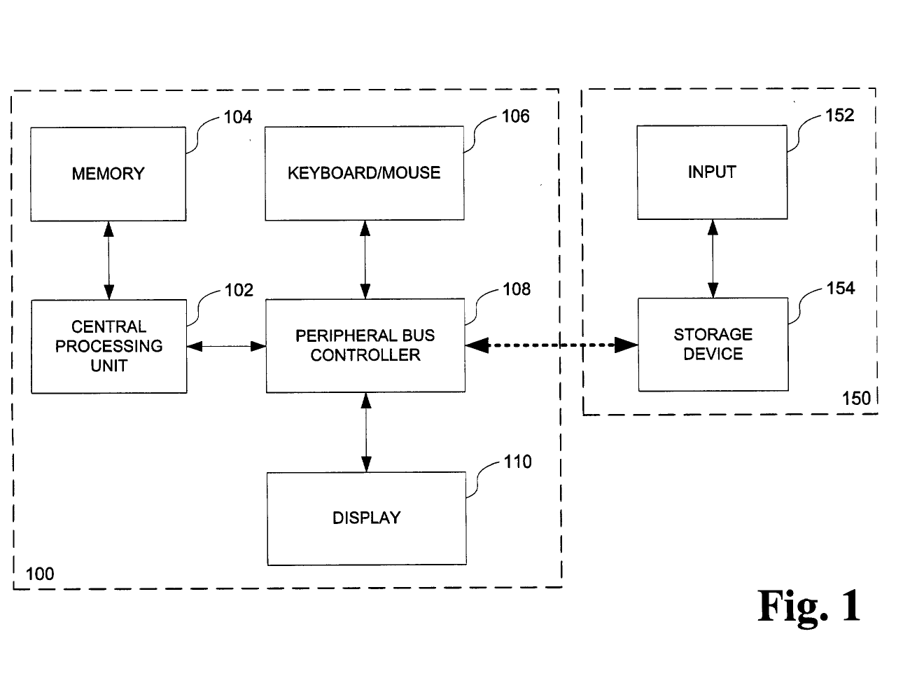

FIG. 1 is a system diagram of a computer system 100 and a external storage device 150 configured in accordance with one embodiment of the present invention, computer system 100 including a central processing unit (CPU) 102 and a memory 104 in communications with CPU 102. CPU 102 is typically a general purpose processor used in computing devices such as personal computers, personal digital assistants (PDA's), workstations, and servers. In addition, memory 104 is typically composed of volatile and non-volatile memory that is use to store code executed by CPU 102 (computer readable code) and other data required for operation of the present invention. For example, the code may include an operating system to control the functioning of computer system 100 and its components, applications that provide additional functionality to computer system 100, or other code or data generated by computer system 100 or the user.

A peripheral bus controller 108 is also coupled to communicate with CPU 102 and is coupled to a computer input device (keyboard/mouse) 106, a display 110, and the external storage device 150. In one embodiment, peripheral bus controller 108 includes support for one or more versions of the Universal Serial Bus (USB) standard, as promulgated by USB Implementers Forum, Inc., and available on the World-WideWeb at http://www.usb.org/. In another embodiment, peripheral bus controller 108 may support other standards as the Institute of Electronics and Electrical Engineers (IEEE) 1394 standard, also known as “Firewire.” The standards typically specify how devices are to connect to peripheral bus controller 108 physically, both mechanically (e.g., plugs, ports, and cables) and electrically (protocols and signal levels). For example, USB specifies the use of a USB cable with specific characteristics as to the dimensions of the connectors and the cable. Other device interconnection standard may be more or less specific. Display 110 is a device through which computer system 100 displays information to a user. Typical displays include computer monitors using such display technologies as cathode ray tube, or liquid crystal display. Computer system 100 also includes the computer input device 106, which is used by the user to issue commands and interact with computer system 100. Computer input device 106 may be such devices as cursor control devices (mice, trackballs, or pen tablets), character input devices (keyboards), or other available devices.

Device 150 includes a storage device 154 connected to peripheral bus controller 108 and a user input device 152. In one embodiment, storage device 154 is a mass storage device such as a hard disk (HD) drive or compact-disc (CD) drive. Storage devices such as device 150 typically include a buffer or cache to store temporary data before it is stored in storage device 154 or is sent back to computer system 100 via peripheral bus controller 108. For example, many CD read-only memory (CD-ROM) drives contain a 2 megabyte buffer to speed access to the device. Other storage devices such as hard drives may have even larger buffers. In addition, computer systems also have data buffers and caches to store data that is to be written to or read from the device. As it is typically unknown to the user what data is in the caches on the computer system or storage device, data loss could occur if device 150 is disconnected from computer system 100 before any data that needs to be stored is not stored. Input device 152, in one embodiment, is a button or switch located in or on device 150 that may be activated by a user to provide a signal to device 150. In another embodiment, input device 152 may be any mechanism located in or on device 150 that allows a user to input a signal to device 150. Input device 152 is located at a location on device 150 that is conveniently reached by the user, but not so prominent to allow accidental triggering.

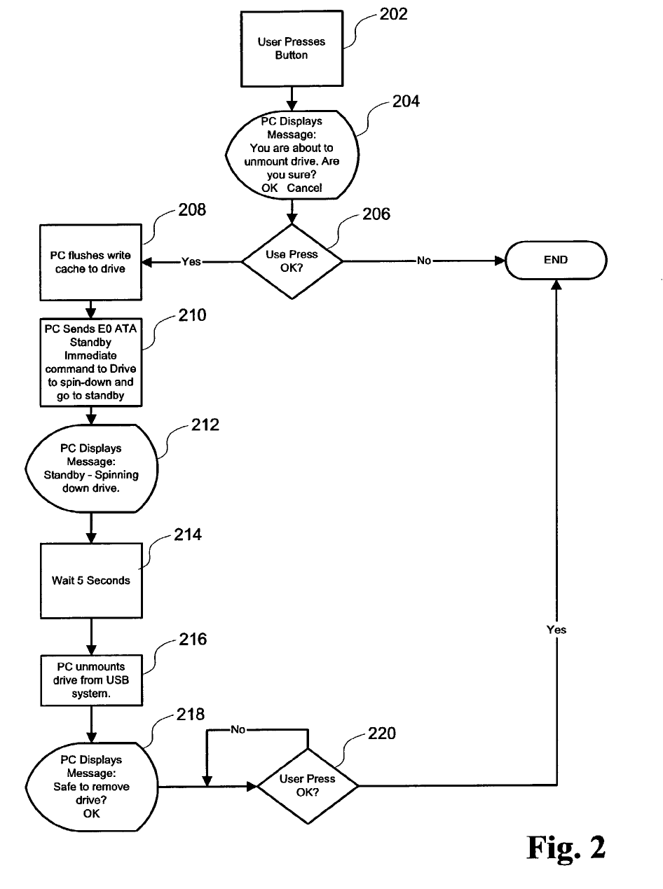

FIG. 2 is a flow diagram illustrating the steps of initiating the flushing a device cache and suspending/shutting-down a device, such as device 150, attached to a system such as computer system 100. In step 202, a user provides an input using input device 152 on device 150 to communicate that the user desires to either detach or suspend/shut-down the device, that is, the user desires to remove the communication link between device 150 and computer system 100 for an indefinitely period of time. This may include pressing a button or toggling a switch. When the input is detected by device 150, it issues a signal such as a USB interrupt signal containing a disconnect request, which is recognized by the device driver software in the operating system running on computer system 100 to initiate the disconnect process.

After the process is initiated, in step 204 computer system 100 displays a message on display 110 to provide warning and asking the user whether the user intends to unmount the device from the computer. If the user responds negatively, then operation ends as it is assumed that the user did not wish to initiate the process and activated input 152 by accident. Otherwise, if the user responds positively, then operation continues with step 208, where computer system 100 will initiate a command to flush all data from its cache and write it to device 150. Thus, computer system 100 will send any data that has should be, but has not been, written to device 150, to device 150. Operation then continues with step 210, where computer system transmits a command to device 154 to initiate its suspend/shut-down procedures, which includes writing all unwritten data. For example, where device 150 is a hard disk drive, computer system 100 will transmit an “E0 ATA Standy Immediate” command to the drive to spin-down its platters and go to standby, which ensures all unwritten data in the system is written to the drive. After computer system 100 sends the command to device 150 in step 210, computer system 100 will display a message to the user informing the user that device 150 is being shut-down. The display is provided as a courtesy display to the user, and in applications may not be necessary if the response time of the system is particularly fast.

In step 214, computer system 100 will wait a pre-determined amount of time to allow device 150 to complete its shut-down process. In one embodiment, computer system 100 will wait at least 5 seconds before proceeding. In another embodiment, computer system 100 will wait a variable amount of time depending on the type of device being shut-down. In yet another embodiment, the delay may be user configurable. After the predetermined time is reached, computer system 100 will unmount device 150 from the operating system in step 216. For example, computer system 100 will clear device 150 from its list of active devices and remove it from the USB sub-operating system. Once device 150 has been unmounted, operation continues with step 218, where computer system 100 will display a message to the user indicating that device 150 is safe to disconnect from computer system 100 and ask the user to acknowledge. For example, computer system 100 may display an alert panel with the message “Please remove drive.” with a graphical user interface button labeled “OK” that can be activated by the user through computer input device 106. The user may at this point disconnect the device by physically removing one end of the cable connecting computer system 100 and device 150, or effectively performing the same thing by turning off device 150. In step 220, computer system 100 will wait until the user responds, and ends the process once the user responds. As described above, the user may respond with interacting with a graphical user interface, or computer system 100 may detect that the user has disconnected device 150.

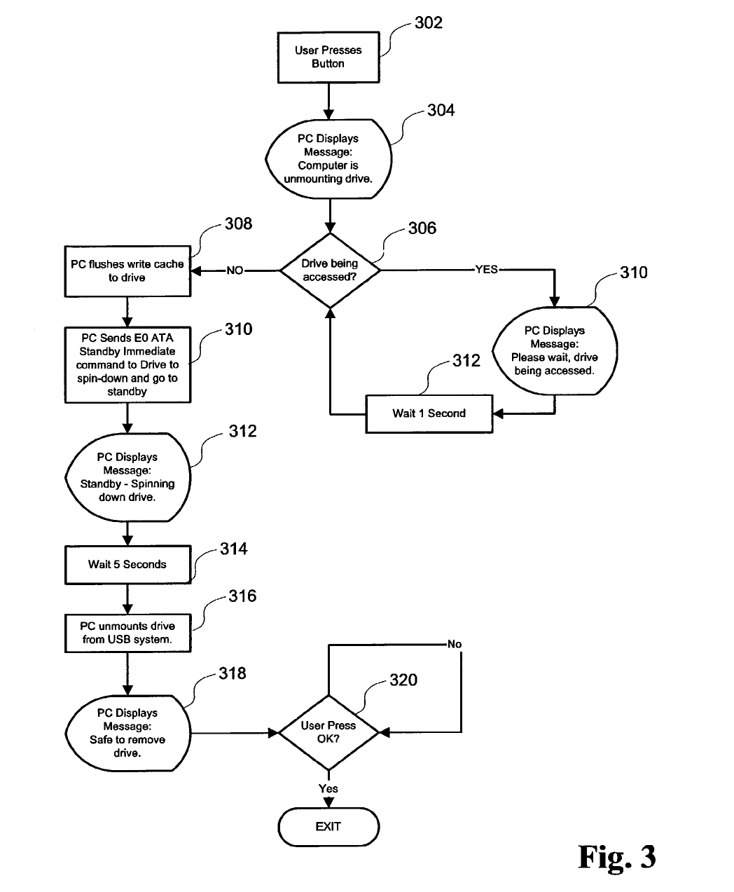

FIG. 3 is a flow diagram illustrating the steps of initiating the flushing a device cache and suspending/shutting-down a device according to another embodiment of the present invention, where there is a data transfer in progress between computer system 100 and device 150 and a user wishes to disconnect device 150. For example, a data file is being transferred from or to device 150 by computer system 100, and the user provides an input using input 152. The operational steps shown in FIG. 3 are substantially similar to the corresponding operational steps described for FIG. 2, except as described herein. Once the user has indicated that the user wishes to disconnect device 150 from computer system 100 in step 302, computer system 100 will display on display 110 that computer system 100 is unmounting, or disconnecting,/suspending/shutting-down device 150, and operation will continue with step 306. In another embodiment, computer system 100 may also query the user to determine the user has not accidentally initiated the process as in the steps described in FIG. 2 confirming that the user wished to disconnect device 150.

In step 306, computer system 100 will determine if device 150 is currently being accessed by any applications or other programs where a data loss will occur if the application is not allowed to complete its access. For example, the operating system could be copying a data file from or to device 150. Or, an application is reading or writing some data from or to device 150, respectively. If computer system 100 detects that device 150 is being accessed, then operation continues with 310, where computer system 100 will provide a message to the user using display 110 and request that the user wait for the current access operation to complete before computer system 100 can shut-down or suspend device 150. In another embodiment, the message displayed may allow the user to cancel the user's request to shut-down or suspend the drive. In yet another embodiment, computer system 100 may display a list of operations accessing device 150, and allowing the user to cancel one or more of them. If the user does not respond, or if it is not desirable to require the computer user to interact with computer system 100, operation will continue to step 312, where there is a delay provided before computer system checks again for whether device is being accessed. The period of the delay may be user configurable, or based on any number of factors, such as the operation currently being performed, the load on the operating system or some other implementation specific factor. For example, the operating system may predict how long a particular operation such as a file transfer is expected to last, and check only after that predicted time has elapsed. Computer system 100 may also prevent the “queuing” of requests after it has received the USB interrupt from device 150 with a disconnect request. Once it is determined that device 150 is not being accessed any more, operation continues with step 308, where computer system 100 operates to unmount device 150 as described in the corresponding steps in the process of FIG. 2, above.

It is to be noted that although the description provided herein is directed towards specific storage device examples, the present invention provides features that to other types of devices. Moreover, although specific devices are shown for the purposes of description, it will be appreciated that the present invention may be employed with any type of electronic device, including, without limitation, consumer electronics, computer or audio systems, and any type of additional components.

1.A method of initiating a suspension of a device connected to a parent device comprising the steps of:
receiving a request from a user;
generating an interrupt signal from the device to the parent device;
concluding any data transfers between the device and the parent device; and,
providing an indication to the user once all data transfers between the device and the parent device have concluded.
